(19) United States
(12) Patent Application Publication
(10) Pub. No.: US 2010/0015995 A1
(43) Pub. Date: Jan. 21, 2010

(54) System and method for automated location information in a unified communication system

(76) Inventors: Rami Caspi, Sunnyvale, CA (US); Jeffrey Blohm, Portola Valley, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/218,948

(22) Filed: Jul. 17, 2008

(51) Int. Cl. H04W 64/00

(52) U.S. Cl. 455/456.1

(57) ABSTRACT

A telecommunications system includes a cellular telephone equipped with a global positioning utility for receiving global positioning samples. The cellular telephone periodically transmits received samples to a location client application running on a computer that also includes a unified communication client suite. The location client application derives a location confidence factor from the samples. The confidence factor is provided to a presence and availability service. Incoming calls and/or notifications can be routed to a user based on the confidence factor.

### BACKGROUND OF THE INVENTION

1. Field of the Invention

This invention relates to telecommunications systems. More particularly, this invention relates to acquisition and distribution of location information in a unified communication system.

2. Description of the Related Art

Unified messaging or communications systems such as Siemens OpenScape provide enhanced communication features and automation based on rules and workflows. User and media presence are key parameters that drive the rules and workflows.

Accurate location information for OpenScape users may be an important additional parameter for the rules and workflow processes. However, acquiring location information is not always easy. Various methods have been considered, including analyzing the IP subnet of the connected routers and translating/converting it to location information; having users manually enter a location; and copying location information from an associated groupware application or client. These methods are not consistently accurate and do not necessarily provide accurate results.

Commonly assigned, co-pending U.S. patent application Ser. No. 10/672,899, titled SYSTEM AND METHOD FOR GLOBAL POSITIONING SYSTEM ENHANCED PRESENCE RULES, describes a system and method for using a globally positioning system to derive location formation for a presence system. Nevertheless, there may be conditions under which the system of that application does not yield optimal location and/or presence results.

### SUMMARY OF THE INVENTION

These and other drawbacks in the prior art are overcome in large part by a system and method according to embodiments of the present invention.

A telecommunications system in accordance with embodiments of the present invention includes a cellular telephone equipped with a global positioning utility for receiving global positioning samples. The cellular telephone periodically transmits received samples to a location client application running on a computer that also includes a unified communication suite. The location client application derives a location confidence factor from the samples. The confidence factor is provided to a presence and availability service. Incoming calls and/or notifications can be routed to a user based on the confidence factor.

A telecommunications system in accordance with embodiments of the present invention includes a cellular telephone including a global positioning utility for collecting a plurality of global positioning samples of a position of the cellular telephone, the global positioning samples including associated time stamps, the cellular telephone including a wireless transmitter for transmitting the plurality of global positioning samples; a laptop computer including a wireless receiver for receiving the plurality of global positioning samples, the laptop computer including a client application for processing the plurality of samples to a single location result and a confidence factor; and a presence service configured to receive the single location result from the client application and distribute the single location result to other users.

According to embodiments of the present invention, a confidence factor is derived according to the following: if a time stamp of a most recent global positioning location is less than approximately two minutes, then the confidence factor is set to “high;” if the time stamp of a most recent global positioning location is older than approximately two minutes, then the confidence factor is “medium” if the time difference between the current time and the last known location is small and the speed is low; and if the time stamp of a most recent global positioning location is older than approximately two minutes, then the confidence factor is “low” if the time difference between the current time and the last known location is large and the speed is high.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary system according to embodiments of the present invention.

FIG. 2 illustrates an exemplary system according to embodiments of the present invention.

FIG. 3 illustrates an exemplary system according to embodiments of the present invention.

FIG. 4A and FIG. 4B illustrate exemplary devices according to embodiments of the present invention.

FIG. 5 is a block diagram illustrating an exemplary device according to embodiments of the present invention.

FIG. 6 illustrates an exemplary device according to embodiments of the present invention.

FIG. 7 is a block diagram illustrating an exemplary device according to embodiments of the present invention.

FIG. 8A and FIG. 8B schematically illustrate operation of embodiments of the present invention.

FIG. 9 is a flowchart illustrating operation of an embodiment of the present invention.

FIG. 10 is a flowchart illustrating operation of an embodiment of the present invention.

FIG. 11 is a flowchart illustrating operation of an embodiment of the present invention.

FIG. 12 is a diagram illustrating operation of embodiments of the present invention.

### DETAILED DESCRIPTION OF EMBODIMENTS OF THE INVENTION

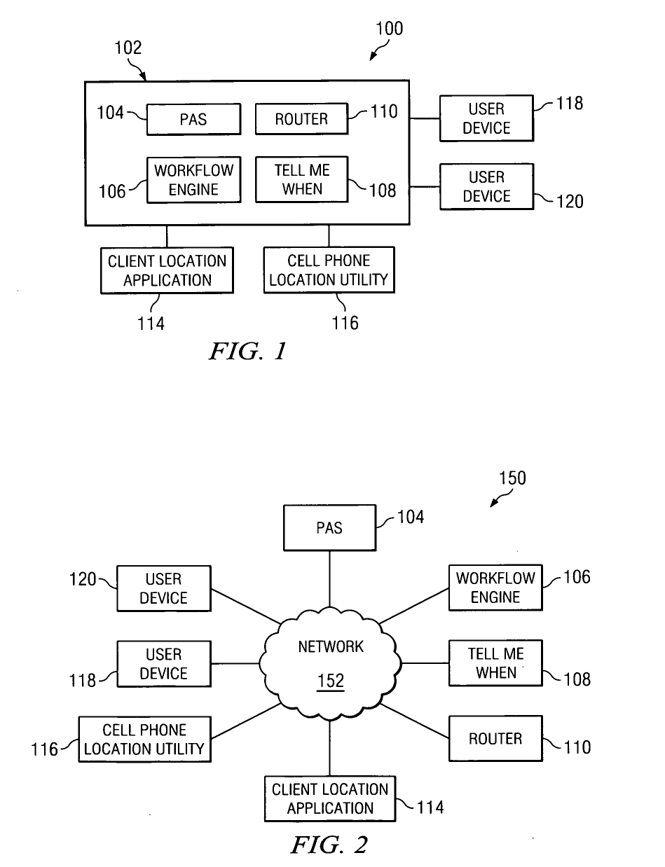

Turning now to the drawings and, with particular attention to FIG. 1, a diagram of a telecommunications system 100 according to an embodiment of the present invention is shown.

In some embodiments, the system 100 includes a unified communications service 102 operably coupled to or in communication with a presence and availability service 104, a workflow engine 106, a notification controller 108, and a router 110. The system 100 may also include a client location application 114 and a location or global positioning utility. 116 operably coupled to or in communication with the unified communications service 102.

User devices, such as the user devices 118, 120 may be operably coupled to or in communication with the unified communications service 102. In some embodiments, a user device may be or include such things as telephones, cellular telephones, PDAs, computers, etc. For example, the user devices 118, 120, may be personal computers implementing the Windows XP™ or Vista™ operating system, a web browser, such as Microsoft Explorer, and the Windows Messenger™ instant messenger system. In addition, the user devices 118, 120 may include telephony and other multimedia messaging capability using, for example, peripheral cameras, Webcams, microphones and speakers (not shown) or peripheral telephony handsets, such as the Optipoint™ handset available from Siemens Communication, Inc.

In some embodiments, a user device 118 may be implemented as a cellular telephone and include or be in communication with a cell phone location software utility 116 in accordance with embodiments of the present invention. As will be explained in greater detail below, the cell phone location software utility 116 collects positioning samples and assigns or receives associated time stamps and communicates the collection of samples and time stamps to the client location application 114.

The client location application 114 may be or include an application that receives the samples and time stamps from the cell phone location software utility 116 and analyzes the samples to generate a single location and a location confidence factor. The client location application 114 may be implemented in hardware and/or software operating on one or more servers, computer systems, host or mainframe computers, workstations, etc. In some embodiments the client location application 114 may be operating on some or all of the same device(s) as other components in the system 100. Typically, the client location application 114 operates on a user computer, such as a laptop or desktop computer. Such a user computer may also implement a communication and presence client suite (not shown) that provides, among other things, a common mailbox for a variety of media, and allows a user to set and receive presence status and contexts.

In some embodiments, the system 100 may include other hardware and/or software components (e.g., gateways, proxy servers, registration servers, presence servers, redirect servers, databases, applications), such as, for example, hardware and software used to support a SIP or other protocol based infrastructure for the system 100 and allow registration of SIP devices in the system 100.

The unified communication system 102 may be implemented as the Siemens OpenScape system, suitably enhanced in accordance-with the present invention. The unified communication system 102 may be implemented in software operating on one or more servers, computer systems, host or mainframe computers, workstations, etc. In some embodiments the unified communication system 102 may be operating on some or all of the same device(s) as other components in the system 100.

In some embodiments, the presence and availability service 104 may be or include an application that uses, collects, refers to, or distributes information associated with parties' presence and associated location information. As will be explained in greater detail below, the presence and availability service 104 may receive a processed location result and a confidence factor associated with the result, as well as one or more distribution and processing rules from the workflow engine 106. The presence and availability service 104 may then distribute the result, confidence factor, and rules to, and for implementation by, other applications. The presence and availability service 104 may be implemented in hardware and/or software operating on one or more servers, computer systems, host or mainframe computers, workstations, etc. In some embodiments the presence and availability service 104 may be operating on some or all of the same device(s) as other components in the system 100.

The presence and availability service 104, may be or include an application that monitors the presence and availability of devices. In some embodiments, the presence and availability service 104 may be or include an application that communicates with or is connected to one or more registered devices (e.g., devices 118, 120), that allows devices to register with the system 100 or helps facilitate their registration, etc. For example, in a SIP environment, the devices 11 8, 120 may be registered with the system 100 and may show up or be described in registration databases as being assigned to particular identities. The presence and availability service 104 may interact with the workflow engine 106 to determine presence status of particular users or devices.

In some embodiments, the presence and availability service 104 may provide context information to other parties, applications, or user devices upon request, periodically, or in accordance with some other plan or procedure. The presence and availability service 104 may include a context manager (not shown) that can monitor when the status of a particular user has changed and, in particular, when that user has contacted another party. It is noted that contact or application events or changes in status that can be monitored can include, for example, a last messaging such as e-mail exchange, or a calendar event, such as a meeting or conference.

The workflow engine 106 may be or include an application that receives location information and a confidence factor and provides an associated location-based set of rules or operations. As will be explained in greater detail below, routing and notification rules may employ the confidence factor in determining whether and where to route calls and/or notifications. The workflow engine 106 may be implemented in hardware and/or software operating on one or more servers, computer systems, host or mainframe computers, workstations, etc. In some embodiments the workflow engine 106 may be operating on some or all of the same device(s) as other components in the system 100.

In addition, one or more user databases (not shown) may be provided for storing user contact lists and other user information that may be accessed by other system components, such as routing and location rules. In some embodiments such user databases may be operating on some or all of the same device(s) as other components in the system 100.

In some embodiments, one or more of the components of the system 100 may be connected or in communication with each other via a communication network. For example, now referring to FIG. 2, a system 150 including the components of the system 100 is illustrated, wherein some or all of the components are in communication via a network 152. The network 152 may be or include the Internet, the World Wide Web, a local area network, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 152 may be implemented using a TCP/IP network and may implement voice or multimedia over IP using, for example, the Session Initiation Protocol (SIP).

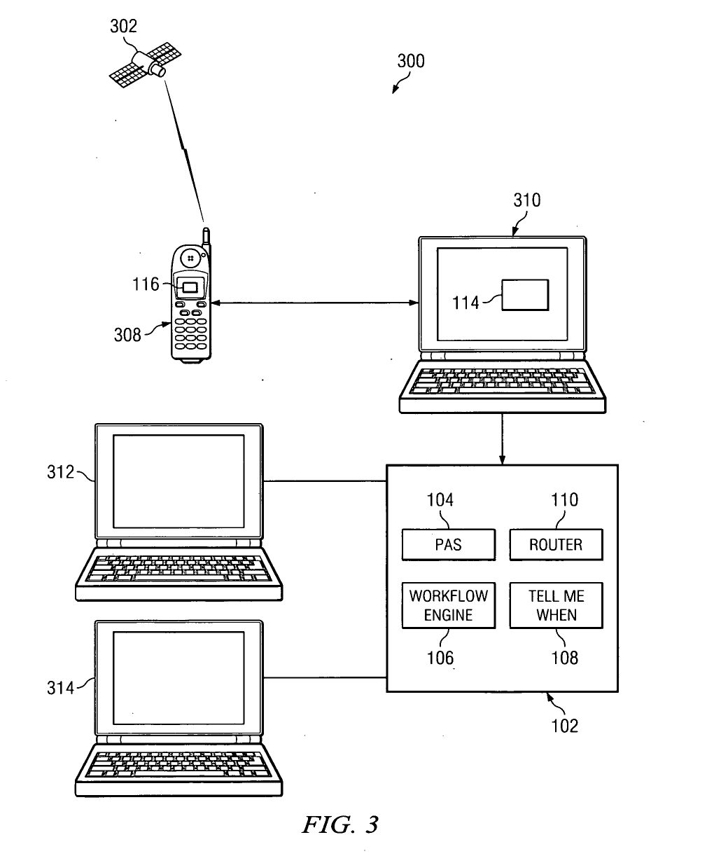

FIG. 3 is a diagram schematically illustrating operation of an embodiment of the present invention. Shown are one or more global positioning satellites 302, a unified communication service 102 in accordance with embodiments of the present invention, implemented as, for example, one or more servers, a user cell phone 308 and a user laptop or personal computer 310. The system 300 may also include one or more user devices 312, 314 associated with other users.

In some embodiments, the positioning satellites may be GPS (global positioning system) satellites, although the present invention is not exclusive to that system. Other embodiments may make use of, for example, GLONASS, Galileo, Compass, IRNSS, etc.

In operation, the cell phone 308 may receive global positioning signals from the satellite(s) 302 and determine a corresponding location from the signals. For example, the location signals may be received on a periodic basis. The cell phone location utility 116 saves a predetermined number of location samples and their time stamps in a buffer or buffers, and communicates the corresponding locations and stamps to the client location application 114 running on the computer 310.

For example, the cell phone 308 and the laptop computer 310 may be equipped with Bluetooth hardware and software or another system for ad hoc wireless networking. Thus, in some embodiments, the location values and time stamps are transmitted according to a Bluetooth protocol. In particular, in some embodiments, the Bluetooth File Transfer Profile may be used, although any suitable Bluetooth profile may be employed. Typically, the location and time stamp data is fetched periodically, although any method may be used. For example, the data can be sent when the buffer(s) are full, or on another basis.

The client location application 114 then compares the time stamps of a predetermined number of the derived locations (e.g., five) with the current time value from the laptop computer internal clock (not shown) to establish a “confidence level” or “confidence factor” for the location indication. A location indication, such as the most recent location, may be determined to be the user location within a certain level of confidence. The most recent location indication, the time stamp, and the corresponding confidence factor are then transferred to the unified communication service 102.

The unified communication service 102 receives the location indication, time stamp, and confidence factor, and provides the information for additional processing to the workflow processor(s), OpenScape clients that query or subscribe to this information, and third party applications that can access the information via OpenScape SDKs.

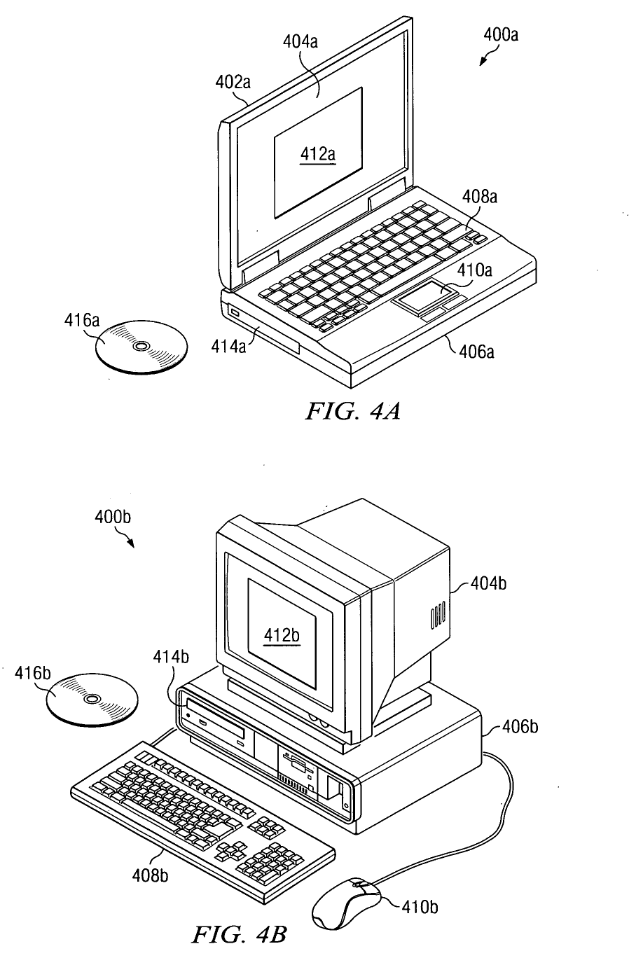

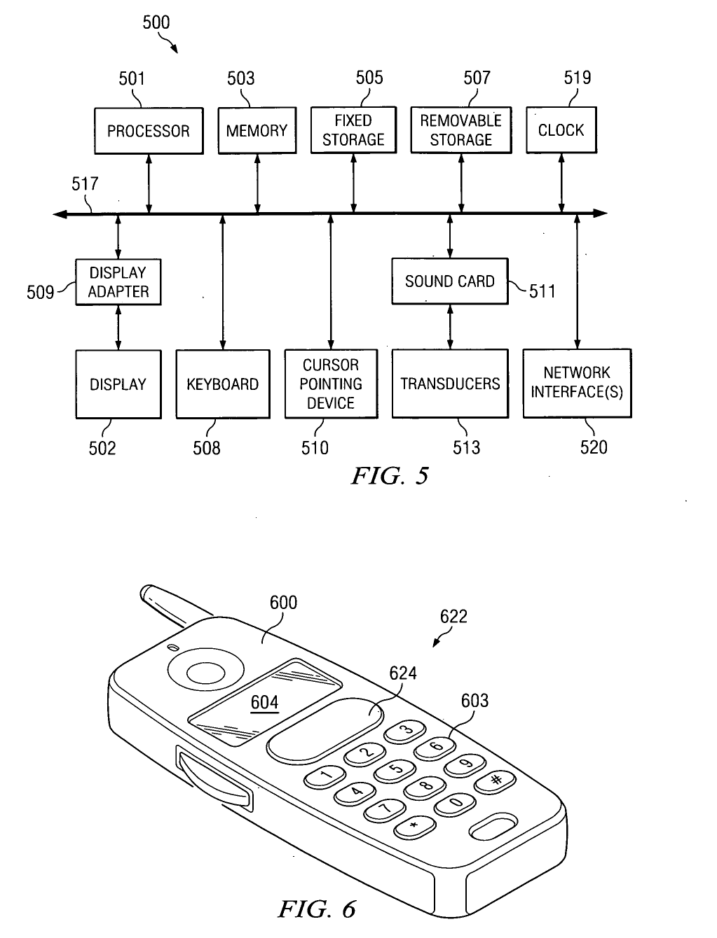

FIG. 4A illustrates an example of a personal computer 400a that can be used to execute embodiments of the invention including, particularly, the client location application 114. In particular, FIG. 4A shows a computer system 400a that includes a display 402a, screen 404a, housing 406a, keyboard 408a, and cursor pointing device 410a. The cursor pointing device 410a can have one or more buttons for interacting with a graphical user interface (GUI) based program, such as program 412a. The program 412a may implement, for example, the client location application 114, as well as a communications and presence client suite (not shown). The housing 406a may house, for example, a CD/DVD RW drive 414a, system memory and a hard drive (see FIG. 5) which can be utilized to store and retrieve software programs incorporating computer code that implements aspects of the invention, data for use with the invention, and the like. Although CD-ROM/DVD 416a is shown as an exemplary computer readable storage medium, other computer readable storage media including floppy disk, tape, flash memory, system memory, and hard drive can be utilized. Additionally, a data signal embodied in a carrier wave (e.g., in a network including the Internet) can be the computer readable storage medium.

FIG. 4B illustrates an example of a computer or server that can be used to execute embodiments of the invention including, particularly, the presence and availability service, the tell me when service, the workflow engine, the location presence engine, and the router. In particular, FIG. 4B shows a computer system 400b that includes a display 402b, screen 404b, housing 406b, keyboard 408b, and cursor pointing device 410b. The cursor pointing device 410b can have one or more buttons for interacting with a graphical user interface (GUI) program, such as program 412b. The program 412b may be representative of, for example, the presence and availability service, the tell me when service, the workflow engine, etc. The housing 406b may house, for example, a CD/DVD RW drive 414b, system memory and a hard drive (see FIG. 5) which can be utilized to store and retrieve software programs incorporating computer code that implements aspects of the invention, data for use with the invention, and the like. Although CDROM/DVD 416b is shown as an exemplary computer readable storage medium, other computer readable storage media including floppy disk, tape, flash memory, system memory, and hard drive can be utilized. Additionally, a data signal embodied in a carrier wave (e.g., in a network including the Internet) can be the computer readable storage medium.

FIG. 5 shows a system block diagram of computer system 500 used to execute software of an embodiment of the invention or use hardware embodiments (e.g., computer 400a or 400b). As in FIG. 4A and FIG. 4B, computer system 500 includes display 502, keyboard 508, and cursor pointing device 510. Computer system 500 further includes subsystems such as a central processor 501, system memory 505, fixed storage 505 (e.g., hard drive), removable storage 507 (e.g., CDROM drive), display adapter 509, sound card 511, transducers 515 (speakers, microphones, and the like), clock 519, and network interface(s) 520. A Pentium™ microprocessor such as the Pentium III™ or IV™ microprocessor, manufactured by Intel Corporation may be used for the processor 501. Other suitable processors may be available from Freescale Semiconductor, Inc., AMD, or Sun Microsystems, Inc. The processor 501 also may be embodied as one or more microprocessors, computers, computer systems, etc.

The network interface(s) 520 may provide for communication to a packet network. Thus, the network interface 520 may be a wireless interface and implement an 802.11x network interface. In addition, in some embodiments, the network interface(s) may be or include a Bluetooth interface.

Other computer systems suitable for use with the invention can include additional or fewer subsystems. For example, another computer system could include more than one processor 501 (i.e., a multi-processor system) or a cache memory.

The system bus architecture of computer system 500 is represented by arrows 517. However, these arrows are illustrative of any interconnection scheme serving to link the subsystems. For example, a local bus could be utilized to connect the central processor to the system memory and/or display adapter. Computer system 500 shown in FIG. 5 is but an example of a computer system suitable for use with the invention. Other computer architectures having different configurations of subsystems can also be utilized.

FIG. 6 illustrates an exemplary wireless or cellular device 622 that may include a cell phone utility according to embodiments of the present invention. As shown, the device includes a housing 600, display 604, cursor control 624, and keypad 603. The keypad and cursor control may be used to access a program, such as a GUI based program, via display 604.

As noted above, the device 622 may be embodied as a wireless or cellular phone, or other wireless device, such as a PDA that is capable of operating in conjunction with a cellular telephone network. In addition, as will be discussed in greater detail below, the cellular telephone 622 may be equipped with a Bluetooth interface for communicating with another wireless device. The telephone 622 may further include a global positioning receiver for receiving global positioning signals.

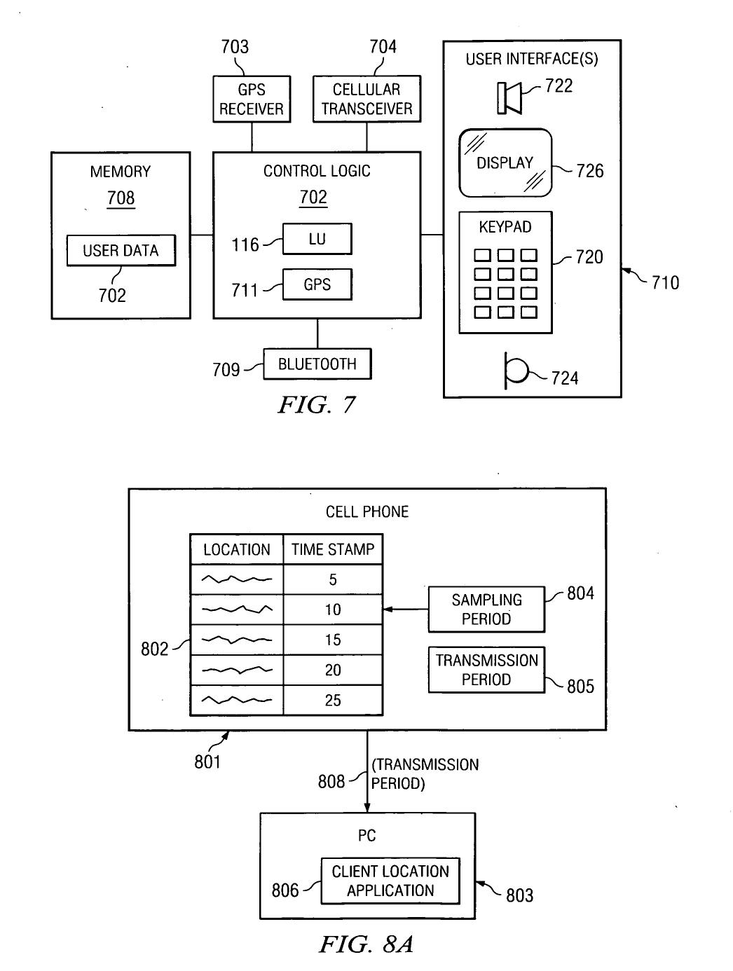

FIG. 7 is a system block diagram of an exemplary cellular telephone 622 in accordance with embodiments of the present invention. The cellular telephone 622 includes control logic 702 that may implement a global positioning processing unit 711 and a cellular telephone location utility 116. Thus, the cellular telephone may also include a GPS receiver 703. In addition, a wireless interface 709, such as a Bluetooth interface, is provided for transmitting received global positioning samples to a computer client application (FIG. 1).

The cellular telephone 622 further includes a cellular transceiver 704 for communicating over a cellular network; and user interface 710, including, e.g., keypad 720, display 726, microphone 724 and speaker(s) 722. A memory 708 may be provided to store user and program data 702. The various controllers and applications may be embodied as various combinations of software and/or firmware running one or more processors in the cellular telephone.

As discussed above, the cellular telephone is configured to receive global positioning signals and transmit them to the computer using, for example, Bluetooth interface 709.

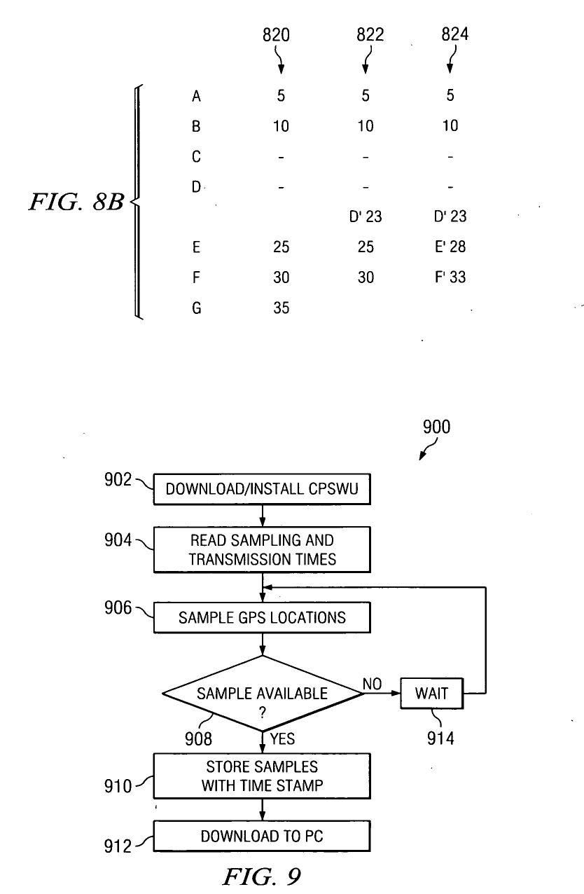

In particular, turning now to FIG. 8A, a diagram schematically illustrating operation of an embodiment of the present invention is shown. Shown is an exemplary GPS data buffer 802, a sampling period buffer 804, and a transmission period buffer 805 in a cell phone 801; and a client location application buffer 806 in a computer 803. In operation, a user can make use of the telephone interface 710 to set a sampling period (or it can be preset), such as, for example, five seconds, as well as a transmission period, say 1 minute (The transmission period can also be preset). Alternatively, the sampling and transmission periods (as well as other user data) can be set on an associated computer and uploaded to the cellular telephone.

Then, every five seconds, as shown at 802, a new location sample is obtained, along with the appropriate time stamp. In the example illustrated, time stamps of 5, 10, 15, 20, 25 are shown, although in practice, “actual” local time, e.g., EST or GMT, would be used. The locations, i.e., the content of the location-time stamp buffers, are then transmitted to the client location application buffer 806, for example on the periodic basis (e.g., 1 min.), as shown at 808.

In some embodiments, as will be explained in greater detail below, while a predetermined number of samples are obtained on a periodic basis, the cell phone utility 116 can compensate for situations where the positioning signals are unavailable. This can occur, for example, if a user enters a building or subway or other location where the positioning signals cannot reach.

In such cases, the cell phone utility 116 can wait until the next occurrence of the sampling period to try to obtain a next sample and thereafter can continue on that period. Alternatively, the cell phone utility 116 can wait until a sample is available and then use that time as the basis for the sampling period or return to the original sampling period. Once the samples have been obtained, they can be transmitted to the client application 114 on a periodic basis, for example. In such cases, the transmission may wait until the buffer is full, or may transmit all available samples.

Turning now to FIG. 8B a diagram schematically illustrating such operation of an embodiment of the invention is shown. Column 820 represents a sequence of samples, taken at a period of five seconds. Samples A and B are taken at the appropriate sampling time. At C and D (i.e., the next two scheduled sampling times), however, no signal is available, so the system waits until E, the next scheduled sampling time, when a signal and sample is available. Final samples are taken at F and G, the subsequent sampling period times.

A different method is shown with regard to column 822. Again, at A and B, signals are available so samples can be taken as scheduled. At C and D, the next two scheduled sampling times, no signals are available, but are available at D′, a time that does not correspond to a scheduled sampling time. However, in this embodiment, as soon as the signal is available, at 23 seconds or D′, a sample is taken. Sampling then resumes at the original time base or next scheduled time, so that samples are taken at E and F, or 25 and 30 seconds.

At column 824, another arrangement is shown. Samples are obtained at A and B (at five and ten seconds, respectively). At C and D, the next scheduled times, however, no signal is available. At D′, or 23 seconds, the signal is available, so a sample is taken. Since the sampling period is five seconds, subsequent samples are taken at E′ and F′, or twenty-eight and thirty-three seconds, respectively. That is, the time base schedule is reset based on the renewed availability.

Turning now to FIG. 9, a flowchart 900 illustrating operation of an embodiment of the present invention is shown. The particular arrangement of elements in the flowchart 900 is not meant to imply a fixed order to the elements; embodiments can be practiced in any order that is practicable.

In a process step 902, a user can download, install, and/or activate the cellular phone location software utility 116. Alternatively, as discussed above, the location utility 116 may be pre-installed on the telephone. It is noted that, alternatively, the utility could be implemented as one or more firmware modules that may be pre-installed or installed by the user.

In a process step 904, the location software utility 116 can read the sampling period and the transmission period. Again, these can be preset or can be manually set by the user via the user interface and controls or uploaded from a computer.

In a process step 906 the location software utility 116 can activate to periodically sample the GPS locations. That is, the utility 116 can cause the telephone to receive GPS signals from the GPS satellites. In a process step 908, if a sample is not available, then the system will wait until it is, in a process step 914. Otherwise, in a process step 910, the location software utility 116 will store the samples in a buffer and apply a time stamp (based on, e.g., an internal or external clock).

In a process step 914, the buffer of samples can be downloaded to the client application 114 at an associated computer. For example, as discussed above, this may be done by the Bluetooth protocol.

As noted above, the location samples and corresponding time stamps are transmitted to the user's client location application 114, which typically runs on the user's laptop computer. The client location application 114 analyzes the location information and time stamps to determine a “current location” value and an associated “confidence factor” for the location. As noted above, the “current location” may be a most recent value, i.e., the one that has a time stamp that is “closest” to the time displayed by the computer's internal clock 519 (FIG. 5). It is noted, however, that other methods may be used to establish a “current location.”

In any case, the client location application 114 compares the time stamps of a predetermined number of recent GPS locations with the current time value of the client or laptop computer to establish a confidence level for the location indication.

In some embodiments, three “levels” of confidence may be defined. These may be “highest,” (or high); “medium,” and “low.” It is noted that more or fewer levels may be defined, and that other factors may be defined as well.

The following algorithm may be used to determine the confidence factor:

If the time stamp of the most recent GPS location is less (i.e. newer) than a predetermined number of minutes ago (e.g., 2 minutes), then the confidence factor value is set to: “Highest”

If the time stamp of the most recent GPS location is larger (i.e. older) than a predetermined number of minutes ago (e.g., 2 minutes), then it means that the GPS satellite link is not available, often due to being inside of a building.

In this case the last few GPS locations and time stamps are checked in order to establish the speed at which the user (of the cell phone and laptop) was traveling.
a. If the time difference between the local laptop time and the last known GPS location time is small and the speed is low then the confidence factor value is set to: “Medium”
b. If the time difference between the local laptop time and the last known GPS location time is large or the speed is high then the confidence factor value is set to: “Low”

When the user subsequently is in a location where the cell phone re-establishes its GPS link and new location and timestamp information is captured, the confidence factor value will be set to a high level again.

A “small” or “large” time value may be arbitrary but predetermined values. A typical “small” value would be about 2 to 4 minutes; a typical “large” value would be about 10 minutes. Likewise, high or low speeds may be arbitrary predetermined values, such as about 30 mph for high and about 3 mph for low.

In practice, any suitable time and speed-based equation or method may be used. One implementation is described by example as follows:

Assume a wandering distance of 1000 feet defines the boundary between a “medium” and “low” confidence factor. Then, the velocity can be multiplied by the time since last measurement to determine a current wandering distance. Suppose, for example, the user is moving at a walking pace of 3 mph, or 264 feet per minute. So if the last measurement was less than around 4 minutes old, the system would the confidence factor is medium. If it was more than 4 minutes old, the confidence is low. Similarly, suppose the user is traveling 60 mph, which is 5280 feet in a minute. If the last measurement is even 12 seconds old, the confidence fact would be low.

It is noted that other confidence metrics and algorithms may be used, and that other time periods may be used as the basis for the confidence evaluation.

The client location application module 114 then transfers the current location value, time stamp, and corresponding confidence value to the communications server 102 and, in particular, to the workflow engine 104.

Once the location and confidence factor are received and associated with the particular user, they can be used in conjunction with user presence to establish routing and notification rules. The rules for routing and notification may be based on a variety of factors.

For example, a user may have multiple devices associated with him. Such devices can include, for example, a personal computer client, a cell phone with voice and text (e.g., SMS) capabilities, voice mail, an assistant, etc.

When an incoming call is received, the called party's location, confidence factor, and routing rules are accessed. For example, if the time stamp is older than a predetermined value, such as twelve hours, or the confidence factor is low, no location based rules may be run (in this case, e.g., the call may be routed to voice mail).

If the confidence factor is high, then the cellular device is in close proximity to the personal computer (i.e., at least Bluetooth distance). In such a case, the call may be routed to the computer communications client. Otherwise, a rule may be written that the call should be sent to the cell phone (or to the assistant or voice mail or some other destination of the user's choice).

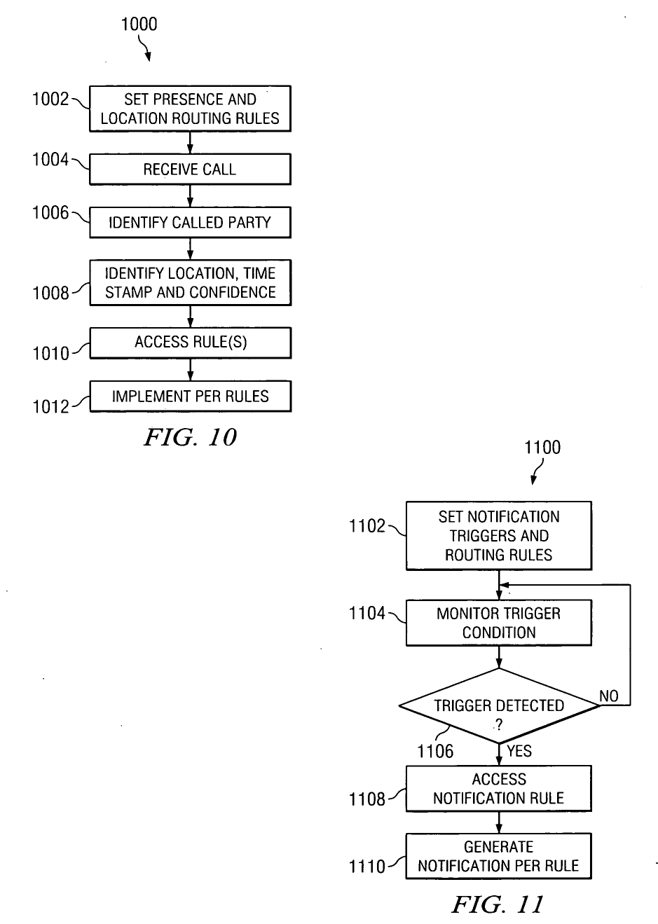

Turning now to FIG. 10, a flowchart 1000 illustrating operation of an embodiment of the present invention is shown. The particular arrangement of elements in the flowchart 1000 is not meant to imply a fixed order to the elements; embodiments can be practiced in any order that is practicable.

Initially, in a process step 1002, a user can set one or more presence and location rules and parameters. As discussed above, this can include setting the rules using the user interfaces of the cell phone, or using the personal computer client and uploading, as necessary, the rules to the communications service 102 (and particularly, the workflow engine 106) via, for example, the Internet. In a process step 1004, the user can receive a call at a designated number.

In a process step 1006, the communications system identifies the called party from the number sent by the caller. In a process step 1008, the party's location is determined or received by the presence service 104 and particularly, the workflow engine 106, as is the confidence factor.

In a process step 1010, the workflow engine 106 accesses the rules for routing a call according to the location, presence, and confidence factor. Finally, in a process step 1012, the call is routed according to the rules.

As discussed above, the confidence factor may also be used to provide or set notifications of various events, such as when using the tell me when utility 108, although notifications of other types may also make use of the location and confidence factor rules. The notification rules may be such that, for example, the user is notified if a party is within an arbitrary distance, say, 5 miles; if the party's confidence factor goes high; if the party's time stamp is older than a predetermined amount.

Similarly, if a predetermined number of participants to a meeting are located on site or within a predetermined distance, then a message might be sent suggesting a physical meeting instead of a telephone call.

The tell-me-when utility 108 may make use of location related attributes to set notification triggers. For example:

Send me notification (“tell-me-when”) a user is within a predetermined distance of my location (e.g., five miles);

Send me notification when a user's location confidence factor goes “low;”

Send me notification when user's time stamp is older than a predetermined age (e.g., 24 hours).

In addition, as noted above, the location related attributes can be used to determine where a notification should be sent. For example:

If confidence factor is high, send notification via pop-up at computer client;

If confidence factor is low or medium, send notification to user cell phone via SMS.

The location information can be presented along with other presence information using a graphical user interface and a confidence factor may be indicated to give the observer a better feel for the accuracy of the information.

Turning now to FIG. 11, a flowchart 1100 illustrating operation of an embodiment of the present invention is shown. The particular arrangement of elements in the flowchart 1100 is not meant to imply a fixed order to the elements; embodiments can be practiced in any order that is practicable.

In a process step 1102, the communications service 102 will receive a set of notification rules, including notification triggers and routing rules. As discussed above, this can include setting the rules using the user interfaces of the cell phone, or using the personal computer client and uploading, as necessary, the rules to the communications service 102 (and particularly, the workflow engine 106) via, for example, the Internet.

In a process step 1104, the communications service 102 and particularly, the tell me when utility 108, will monitor the user and other party status for the bigger condition(s). That is, party location, time stamps, presence, and confidence factors may all be monitored.

In a process step 1106, if a trigger condition is detected, the system will access a notification rule, in a process step 1108. The communications system 102 will then generate a notification using the medium appropriate to the rule.

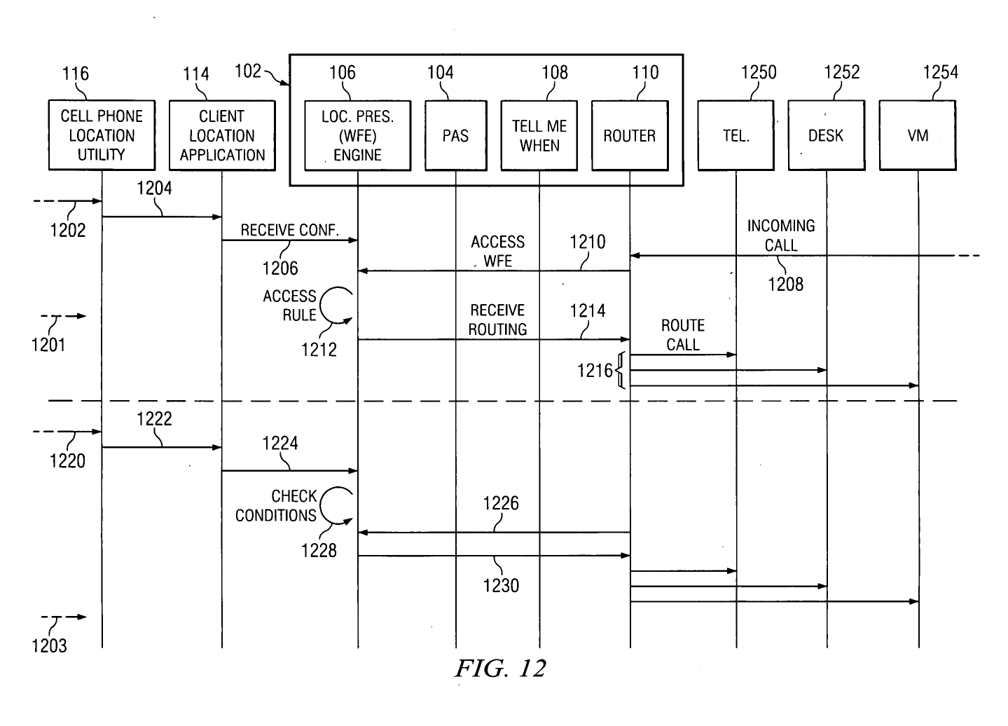

FIG. 12 is a diagram schematically illustrating call routing and notification using the confidence factors and time stamps in accordance with embodiments of the present invention.

Shown is cell phone location utility 116, client location application 114, and server 102 including workflow engine 106, presence and availability service 104, tell me when utility 108, and router 110. Also shown are additional user devices that may be associated with a cell phone user, such as a desktop or cellular telephone 1250, desktop client 1254, and voicemail 1256.

Call routing is illustrated at 1201. At 1202, the cell phone location utility 116 can receive one or more location samples, as discussed above. At 1204, the samples and associated time stamps can be sent to the client location application 114, for example, via Bluetooth or another suitable interface. At 1206, the client location application 114 generates and sends the confidence factor to the communication server 102 and, in particular, the workflow engine 106. It is noted that, in some embodiments, the location information and confidence factor may be provided to the PAS 104, which can then distribute it as necessary, e.g., to the workflow engine 106 upon demand.

At 1208, an incoming call or other communication can be received at the-router 110, which identifies the call for the called party user. It accesses or otherwise receives information from the workflow engine 108 at 1210-1212 to receive the appropriate routing. The workflow engine 106 accesses an associated rules database concerning the called party and provides the rules to the router 110 at 1214. (As discussed above, this can be done either by the workflow engine itself or by the workflow engine after accessing the PAS 104). At 1216, the router 110 routes the call, as appropriate, to, for example, any of the devices 1250, 1252, 1254. If the call has a high confidence factor, then the call may be routed, for example, to the desktop client 1252. Otherwise, it may be routed to the cell phone 1250.

Notification, such as tell me when notification, is shown at 1203. At 1220, global positioning signals can be received at the cell phone location utility 116. At 1222, the location software utility 116 sends the samples and associated time stamps to the client location application 114. At 1224, the received locations(s) and confidence factor can be received at the workflow engine 1224. At 1226, the notification or tell me when unit 108 sends its rules to the workflow engine 106. At 1228, the workflow engine 106 processes the rule and, upon detection of a condition, at 1230 can cause the appropriate communication module of the communications service to generate and send the notification to the rules-designated device in the appropriate media. Alternatively, as noted above, the location information may be kept by the PAS 104 and made available upon request to the workflow engine 106 which may occur, for example, upon detection of a notification condition.

While specific implementations and hardware/software configurations for the various devices have been illustrated, it should be noted that other implementations and hardware configurations are possible and that no specific implementation or hardware/software configuration is needed. Thus, not all of the components illustrated may be needed for the computer implementing the methods disclosed herein.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described embodiments are intended to illustrate the principles of the invention, but not to limit the scope of the invention. Various other embodiments and modifications to these preferred embodiments may be made by those skilled in the art without departing from the scope of the present invention.

What is claimed is:

1. A telecommunications system, comprising:
a cellular telephone including a global positioning utility for collecting a plurality of global positioning samples of a position of the cellular telephone, the global positioning samples including associated time stamps, the cellular telephone including a wireless transmitter for transmitting the plurality of global positioning samples;
a laptop computer including a wireless receiver for receiving the plurality of global positioning samples, the laptop computer including a client application for processing the plurality of samples to a single location result and a confidence factor; and
a presence service configured to receive the single location result from the client application and distribute the single location result to other users.

2. A telecommunications system in accordance with claim 1, the cellular telephone including a plurality of buffers for storing the plurality of global positioning samples and associated time stamps.

4. A telecommunications system in accordance with claim 2, wherein the cellular telephone is configured to obtain a sample according to predetermined intervals.

4. A telecommunications system in accordance with claim 4, wherein the predetermined intervals are periodic intervals.

5. A telecommunications system in accordance with claim 4, wherein the cellular telephone is configured to wait until a global positioning signal is available for an interval's sampling if a global positioning signal had not been available at the sampling interval prior to resuming the sampling at a next predetermined interval.

6. A telecommunications system in accordance with claim 4, wherein the cellular telephone is configured to transmit the plurality of global positioning samples when the plurality of buffers is full.

7. A telecommunications system in accordance with claim 4, wherein the cellular telephone is configured to transmit the plurality of global positioning samples at predetermined intervals.

8. A telecommunications system in accordance with claim 1, wherein a confidence level is high if a time stamp of a most recent location is less than a predetermined period.

9. A telecommunications system in accordance with claim 8, wherein a confidence level is low depending on a time since last location and speed.

10. A telecommunications system in accordance with claim 1, wherein a confidence factor is derived according to the following:
if a time stamp of a most recent global positioning location is less than approximately two minutes, then the,confidence factor is set to “high;”
if the time stamp of a most recent global positioning location is older than approximately two minutes, then the confidence factor is “medium” if the time difference between the current time and the last known location is small and the speed is low; and
if the time stamp of a most recent global positioning location is older than approximately two minutes, then the confidence factor is “low” if the time difference between the current time and the last known location is large and the speed is high.

11. A telecommunications system in accordance with claim 1, wherein the presence system distributes the location result and generates notifications based on the confidence factor.

10. A telecommunications system in accordance with claim 1, further including a router for routing media to a user based on the confidence factor.

14. A telecommunications method, comprising:
collecting a plurality of global positioning samples of a position of the cellular telephone, the global positioning samples including associated time stamps;
receiving the plurality of global positioning samples at a computer, the computer including a client application for processing the plurality of samples to a single location result and a confidence factor; and
receiving the single location result from the client application and distributing the single location result to other users.

14. A telecommunications method in accordance with claim 14, storing the plurality of global positioning samples and associated time stamps in a plurality of buffers at the cellular telephone.

15. A telecommunications method in accordance with claim 14, wherein the cellular telephone is configured to obtain a sample according to predetermined intervals.

16. A telecommunications method in accordance with claim 15, wherein the predetermined intervals are periodic intervals.

17. A telecommunications method in accordance with claim 14, wherein the cellular telephone is configured to wait until a global positioning signal is available for an interval's sampling if a global positioning signal had not been available at the sampling interval prior to resuming the sampling at a next predetermined interval.

18. A telecommunications method in accordance with claim 14, wherein the cellular telephone is configured to transmit the plurality of global positioning samples when the plurality of buffers is full.

19. A telecommunications method in accordance with claim 14, wherein the cellular telephone is configured to transmit the plurality of global positioning samples at predetermined intervals.

20. A telecommunications method in accordance with claim 14, wherein a confidence level is high if a time stamp of a most recent location is less than a predetermined period.

21. A telecommunications method in accordance with claim 20, wherein a confidence level is low depending on a time since last location and speed.

22. A telecommunications method in accordance with claim 14, wherein a confidence factor is derived according to the following:
if a time stamp of a most recent global positioning location is less than approximately two minutes, then the confidence factor is set to “high;”
if the time stamp of a most recent global positioning location is older than approximately two minutes, then the confidence factor is “medium” if the time difference between the current time and the last known location is small and the speed is low; and
if the time stamp of a most recent global positioning location is older than approximately two minutes, then the confidence factor is “low” if the time difference between the current time and the last known location is large and the speed is high.

24. A telecommunications method in accordance with claim 14, including distributing the location result and generates notifications based on the confidence factor.

24. A telecommunications method in accordance with claim 14, further including routing media to a user based on the confidence factor.
